(19) United States
(12) Patent Application Publication
(10) Pub. No.: US 2023/0188195 A1
(43) Pub. Date: Jun. 15, 2023

(54) EFFICIENT ENHANCED SR FAILURE HANDLING FOR SR SWEEPING

(71) Applicant: TELEFONAKTIEBOLAGET LM ERICSSON (PUBL), Stockholm (SE)

(72) Inventors: Min Wang, LULEÅ (SE); Jan Christoffersson, LULEÅ (SE)

(21) Appl. No.: 17/924,337

(22) PCT Filed: May 12, 2021
(86) PCT No.: PCT/IB2021/054067

§ 371 Date: Nov. 9, 2022

Related U.S. Application Data
(60) Provisional application No. 63/024,650, filed on May 14, 2020.
(60) Provisional application No. 63/024,712, filed on May 14, 2020.

(51) Int. Cl. H04B 7/06; H04B 7/0408; H04W 76/18

(52) U.S. Cl. CPC H04B 7/0695; H04B 7/0408; H04W 76/18

(57) ABSTRACT

There is provided a method in a wireless device configured with multiple scheduling request (SR) configurations and a set of uplink beam candidates for at least one of the SR configurations. The method may comprise: transmitting a SR to a network node using a first uplink beam of the set, determining a second uplink beam from the set to retransmit the SR, in absence of receiving a grant of resources for data transmissions, and triggering a SR failure after transmitting the SR using a subset of the uplink beams of the set.

### RELATED APPLICATIONS

This application claims the benefits of priority of U.S. Provisional Pat. Application No. 63/024650, entitled “Efficient enhanced SR failure handling for SR sweeping” and filed at the U.S. Pat. and Trademark Office (USPTO) on May 14, 2020, and the priority of U.S. Provisional Pat. Application No. 63/024712, entitled “Fallback mechanism for beam-based SR transmission” and filed at the USPTO on May 14, 2020, the content of both applications is incorporated herein by reference.

### TECHNICAL FIELD

The present description generally relates to wireless communication systems, and particularly, to methods for efficient enhanced Scheduling Request (SR) failure handling for SR Sweeping and for beam-based SR transmission fallbacks.

### BACKGROUND

Beamforming is expected to be widely applied for New Radio (NR) operation in mm-wave bands for both transmission and reception. For uplink (UL) transmission, a spatial relation needs to be established and understood by both User Equipment (UE) and gNB before transmission in the UL is conducted. A spatial relation is defined between an UL channel/reference signal (Physical Uplink Shared Channel (PUSCH), Physical Uplink Control Channel (PUCCH), Sounding Reference Signal (SRS)) and either a donwlink (DL) reference signal (Channel State Information-Reference Signal (CSI-RS), Synchronization Signal (SS)/Physical Broadcast Channel (PBCH block)) or another UL reference signal (e.g. SRS). If UL channel/signal A is spatially related to reference signal B, it means that the UE should beamform A in the same way as it received/transmitted B. By establishing a spatial relation, the UE gets to know in which direction to beamform its transmission signal towards the targeted gNB, and the gNB also understands how to tune its receive (RX) beam towards the UE.

NR supports a diverse set of use cases and a diverse set of deployment scenarios. The later includes deployment at both low frequencies (100 s of MHz), and very high frequencies (mm waves in the tens of GHz). Two operation frequency ranges (FRs) are defined in NR Release (Rel)-15: FR1 from 410 MHz to 7125 MHz and FR2 from 24.250 GHz to 52.6 GHz.

### Scheduling Request

In NR, the Scheduling Request (SR) is used for requesting UL-Shared (SCH) resources for new transmissions. A UE in connected mode may be configured with zero, one, or more SR configurations, with each SR configuration corresponding to one or multiple logical channels. An SR configuration consists of a set of PUCCH resources for SR across different Bandwidth Parts (BWPs) and cells, also referred to as SR resources in the standard. There is at most one SR resource assigned to a SR configuration in a BWP in a serving cell. An SR resource configuration includes a SR periodicity and time offset parameter (periodicityAndOffset) and a PUCCH resource ID. The SR periodicity and time offset parameter specifies the SR transmission occasions in time domain, and the PUCCH resource ID indicates which one of the PUCCH resources in the PUCCH configuration should be used for SR transmission.

### Beam-Forming Centric Transmission for NR Operation in MM-Wave Frequency

As the operating frequency of wireless networks increases and moves to milli-meter wave territory, data transmission between nodes suffers from high propagation loss, which is proportional to the square of the carrier frequency. Moreover, milli-meter wave signal also suffers from high oxygen absorption, high penetration loss and a variety of blockage problems. On the other hand, with the wavelength as small as less than a centi-meter, it becomes possible to pack a large amount (tens, hundreds or even thousands) of antenna elements into a single antenna array with a compact formfactor, which can be widely adopted in a network equipment and a user device. Such antenna arrays/panels can generate narrow beams with high beam forming gain to compensate for the high path loss in mm-wave communications, as well as providing highly directional transmission and reception pattern. As a consequence, directional transmission and reception are the distinguishing characteristics for wireless networks in mm-wave bands. In addition, a transmitter/receiver can typically only transmit/receive in one or a few directions at any given time.

### Spatial Relations for PUCCH

Rel-15 NR has introduced the concept of PUCCH-SpatialRelationInfo (see 3GPP TS 38.213) for PUCCH transmissions, which is used to inform the UE how to tune its transmitter antenna array. For PUCCH, the UE is configured with PUCCH-SpatialRelationInfo relations to other signals. The other signals can either be an SS/PBCH block, a CSI-RS or an SRS as defined in 3GPP TS 38.213.

After configuring the UE with a list of spatial relations, the gNB activates one of them using a Medium Access Control (MAC) control element (CE). The update will typically come as a response to that the UE has reported a stronger received power for another reference signal than the one the current spatial relation is associated with. Thus, as the UE moves around in the cell, the UE provides CSI reports to the gNB, based on which the gNB will update the currently active spatial relation.

In Rel-16, an Enhanced PUCCH Spatial Relation Activation/Deactivation MAC CE is introduced (see FIG. 1), which allows the gNB to update spatial relations for multiple PUCCH resources. Correspondingly, the space of Spatial Relation Info ID is extended from 8 to 64.

### Spatial Relations for PUSCH Using Configured Grants

Two types of Configured Grant (CG) UL transmission schemes have been supported in NR since Rel-15, referred to as CG Type1 and CG Type2 in the standard. The major difference between these two types of CG transmissions is that for CG Type1, an uplink grant is provided by RRC configuration and activated automatically, while in the case of CG Type2, the uplink grant is provided and activated via L1 signaling, i.e., by an UL DCI with Cyclic Redundancy Check (CRC) scrambled by configured-scheduling-radio network temporary identifier (CS-RNTI). In both cases, the spatial relation used for PUSCH transmission with Configured Grant is indicated by the uplink grant, either provided by the RRC configuration or by an UL DCI. The uplink grant contains an srs-ResourceIndicator field, pointing to one of the SRS resources in the SRS resource configuration, which can be configured in-turn with a spatial relation to a DL RS (SSB or CSI-RS) or another SRS resource.

With the SRS resource indicator (SRI) in the uplink grant and the RRC SRS resource configuration, PUSCH with Configured Grant is supposed to be transmitted with the same precoder or beamforming weights as the one used for the transmission of the reference SRS.

### Scheduling Request

As described in 3GPP TS 38.321, clause 5.4.4, the SR is used for requesting UL-SCH resources for new transmission. The MAC entity may be configured with zero, one, or more SR configurations. An SR configuration consists of a set of PUCCH resources for SR across different BWPs and cells. For a logical channel or for SCell beam failure recovery (see clause 5.17) and for consistent Listen Before Talk (LBT) failure (see clause 5.21), at most one PUCCH resource for SR is configured per BWP.

Each SR configuration corresponds to one or more logical channels or to SCell beam failure recovery and/or to consistent LBT failure. Each logical channel, and consistent LBT failure, may be mapped to zero or one SR configuration, which is configured by RRC. A SR failure can be handled as described in TS 38.321, clause 5.4.4 and clause 5.4.5.

### Beam Failure Detection and Recovery

As specified in the 3GPP TS 38.321 v 16.0.0 clause 5.1.17, the MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

### Directional LBT

As captured in the 3GPP TR 38.889 V16.0.0, using directional LBT for beamformed transmissions, i.e. LBT performed in the direction of the transmitted beam, has been studied for NR unlicensed operation in 5 G Hz frequency. Compared to the omni-directional LBT, directional LBT can lead to better channel access probability. As a result, better spatial reuse may be achieved.

It may be unnecessary for NR unlicensed to apply multi-beam/multi—SSB NR—U operation at sub-7 GHz frequency region. Single beam operation in low frequency unlicensed spectrum (e.g., <7 GHz) provides more benefits to SS/PBCH transmissions compared to beamforming with beam sweeping operation. For unlicensed spectrum, a UE’s RF output power is normally restricted. This means that if a UE is able to reach maximum output power with an omni-directional transmission, a directional transmission with a high beamforming gain may not give additional coverage in unlicensed spectrum.

### SUMMARY

There are still some problems. Beamforming is expected to be widely applied for NR operation in mm-wave bands for both transmission and reception. For UL transmission, a spatial relation needs to be established and understood by both UE and gNB before transmission in the UL is conducted. A spatial relation is defined between an UL channel/reference signal (PUSCH, PUCCH, Sounding Reference Signal (SRS)) and either a DL reference signal (CSI-RS, SS/PBCH block) or another UL reference signal (SRS). If UL channel/signal A is spatially related to reference signal B, it means the UE should beamform A in the same way as it received/transmitted B. By establishing a spatial relation, the UE gets to know in which direction to beamform its transmission signal towards the targeted gNB, and the gNB also understands how to tune its RX beam towards the UE.

As described in the above section entitled “Spatial relations for PUCCH”, for PUCCH based SR, the UE is configured with PUCCH-SpatialRelationInfo relations to other signals. The other signals can either be an SS/PBCH block, a CSI-RS or an SRS via RRC signaling. After configuring the UE with a list of spatial relations, the gNB activates one of them using a MAC CE. The update will typically come as a response to the UE having reported a stronger received power for another reference signal than the one the current spatial relation is associated with. Thus, as the UE moves around in the cell, the UE provides CSI reports to the gNB, based on which the gNB will update the currently active spatial relation.

Uplink beam misalignment between the gNB and UE may occur. The gNB with analog beamforming capability can only listen to UL transmissions in one direction (per antenna panel) at a time. To solve this, the gNB can periodically sweep through all beams in the cell for periodic UL transmissions in relevant transmission occasions. Periodic UL transmission resources for multiple UEs can be configured in the same OFDM symbol(s) by means of frequency or code multiplexing to improve resource efficiency. A gNB with analog beamforming capability should multiplex periodic UL transmission resources in the same time occasion only for UEs located in the same beam coverage area, so that the gNB can receive the periodic UL transmissions from the UEs with the same RX beam. In other words, in case there are simultaneous SR transmissions by UEs from different directions, it would be difficult for the gNB to decode all directions due to the analog beamforming capability limitation. In case of SR transmissions, a UE that fails to receive the grant would retransmit the SR at the next time occasions which cause extra latency. In an extreme case, a PUCCH-SR failure may be triggered due to the UE having reached the maximum transmission attempts for an SR configuration, which would trigger the UE to perform a Random Access procedure. This would lead to even longer latency for the UE to get a grant.

There may be several possible reasons why the UE does not receive the grant in time.

Reason 1: When the UEs move around in the cell across different beam coverage areas, the gNB needs to frequently re-configure periodic UL transmission resources for the UEs by dedicated signaling (i.e., RRC, MAC CE or DCI). However, an accurate beam alignment requires not only that the UE provides CSI reports in time, but also requires that the gNB sends the signaling in time. This is not always feasible, especially when the UE moves fast and/or there is high signaling load in the cell. Hence, for an SR transmission, it may happen that the UE is transmitting in the wrong direction or that the gNB is listening in the wrong direction.

Reason 2: There may be high congestion or interference in a specific direction/beam. Any uplink transmission on that beam may be therefore blocked.

Reason 3: For NR unlicensed operation beyond 52.6 GHz range, a UE may be configured to apply directional LBT prior to any uplink transmission. In this case, the UE may experience consistent directional LBT failures.

In the existing NR releases (up to NR Rel-16), after configuring the UE with a list of spatial relations, the gNB only activates one of them using a MAC CE for every PUCCH SR resources. In this case, a UE will typically use the same beam to transmit a triggered SR for a long time. A UE that fails to receive the grant would retransmit the SR at the next time occasions using the same beam (even though its location might have changed) which causes extra latency. There may be other beams which may be used by the UE. However, the gNB may not be able to update the beam direction in time, since that would require the UE to provide CSI report timely, which is not always possible for the UE to do so.

Therefore, there is a need to SR enhancement for solving the above issues.

Generally speaking, there are provided methods to control the triggering of SR failure when UL beam sweeping is applied for SR transmissions. The methods include not triggering SR failure until a number of different UL transmission beams have been tried, for example. It should be noted that beam sweeping and beam switching can be used interchangeably in this disclosure.

For example, the UE is allowed to perform autonomous beam switching from one direction to another direction in case the UE does not receive a grant as a response to its SR transmission in a direction.

For each beam, in relation to the UE autonomous beam switch trigger, a configured time period or a configured number of transmission attempts is configured which allows the UE to switch to a different beam if the UE cannot get a transmission grant from the gNB after that configured time period has expired or configured maximum number of transmission attempts on the current beam has been reached.

The UE is configured with a set of beams/spatial relations for PUCCH by the gNB which allows the UE to perform autonomous beam switching within the set.

In an SR configuration, after the UE has attempted all configured beams/spatial relations for a triggered PUCCH-SR, the UE fallbacks to a RACH configuration to initiate a Random Access procedure.

For example, the UE can first fallback to a 2-step RACH configuration (if configured) to initiate a RACH procedure. After a configured number of RACH transmission attempts, or a configured time period for RACH transmission attempts, if the UE has not received a grant as a response to its transmitted SR, the UE can further fallback to a 4-step RACH configuration to initiate a Random Access procedure.

For a UE configured with a set of PUCCH-SR resources/configurations, the UE may be also configured with a set of RACH resources/configurations. Different from the existing SR transmission mechanism (up to NR Rel-16), for a triggered/selected SR, the UE may choose to transmit the SR via a PUCCH-SR resource or a RACH resource based on one of the below conditions:
Signaling from the gNB; the gNB may send signaling to a UE on the transmission choice for a specific SR event to use either PUCCH-SR resource or 2-step RACH resource or 4-step RACH resource. For every beam/spatial relation, the signaled transmission choice may be different.
Measured radio quality in terms of the measurement quantities such as Reference Signal Receive Power (RSRP), Reference Signal Received Quality (RSRQ), signal-to-interference-plus-noise ratio (SINR), Received Signal Strength Indicator (RSSI), channel occupancy, and LBT/CCA failure statistics (such as failure counter, or failure ratio) etc. Based on the measurement results, the UE selects a corresponding transmission choice.

In an example, the UE chooses a PUCCH-SR resource only in case the measured RSRP of a beam/spatial relation is above a configured first threshold.

In an example, the UE chooses a 2-step RACH resource only in case the measured RSRP of a beam/spatial relation is below a configured first threshold and above a second configured threshold. The UE chooses a 4-step RACH resource only in case the measured RSRP of a beam/spatial relation is below a second configured threshold.

According to an aspect, some embodiments include methods performed by a wireless device. A method may comprise: transmitting a SR to a network node using a first uplink beam of the set; determining a second uplink beam from the set to retransmit the SR, in absence of receiving a grant of resources for data transmissions; and triggering a SR failure after transmitting the SR using a subset of the uplink beams of the set.

According to another aspect, some embodiments include a wireless device configured, or operable, to perform one or more functionalities (e.g. actions, operations, steps, etc.) as described herein.

In some embodiments, the wireless device may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the wireless device may comprise one or more functional modules configured to perform one or more functionalities as described herein.

According to an aspect, some embodiments include methods performed by a network node. A method may comprise: configuring a SR failure to be triggered after the wireless device has transmitted the SR using a subset of the uplink beams of the set; and sending the configuration to the wireless device.

According to another aspect, some embodiments include a network node configured, or operable, to perform one or more functionalities (e.g. actions, operations, steps, etc.) as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the network node may comprise one or more functional modules configured to perform one or more functionalities as described herein.

According to yet another aspect, some embodiments include a non-transitory computer-readable medium storing a computer program product comprising instructions which, upon being executed by processing circuitry (e.g., at least one processor) of the network node or the wireless device, configure the processing circuitry to perform one or more functionalities as described herein.

The advantages/technical benefits of the embodiments of the present disclosure are:
The methods herein ensure that a UE tries SR transmissions on different UL beams before triggering SR failure, hereby ensuring that beam misalignment will not prevent the gNB from receiving the SR.
The mechanism/methods also ensure that the UE does not fall back to the RA procedure too early, to avoid unnecessary scheduling delay due to the RA procedure.
The impact of UL beam failure or beam misalignment on beam management is reduced.
Reducing the occurrence of mis-triggering of beam failures for SRs.
Reducing the delay for UL data transmission.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates an Enhanced PUCCH spatial relation Activation/Deactivation MAC CE (as shown in FIG. 6.1.3.25-1 of 3GPP 38.321 V16.0.0).

FIG. 2 is a flow chart of a method in a wireless device, in accordance with an embodiment.

FIG. 3 is a flow chart of a method in a network node, in accordance with an embodiment.

FIG. 4 illustrates one example of a wireless communications system in which embodiments of the present disclosure may be implemented.

FIGS. 5 and 6 are block diagrams that illustrate a wireless device according to some embodiments of the present disclosure.

FIGS. 7 and 8 are block diagrams that illustrate a network node according to some embodiments of the present disclosure

FIG. 9 illustrates a virtualized environment of a network node, according to some embodiments of the present disclosure.

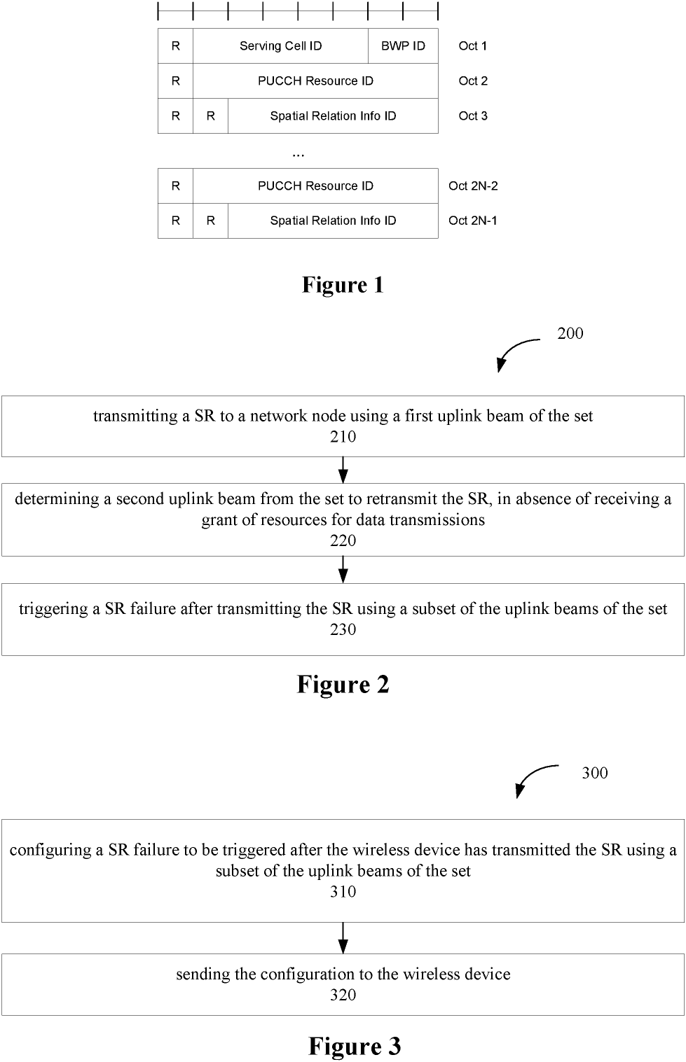

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof. Also, in this disclosure, the terms “a set of uplink beams” and “a set of beam candidates” can be used interchangeably.

The term SR failure is used in this disclosure. If a UE has reached the maximum SR transmission attempts for an SR configuration or other conditions, the UE declares an SR failure for the SR configuration, and may need to take recovery actions, such as performing the RA procedure. The exemplary embodiments below are not restricted by these terms. Any similar term is equally applicable below. The proposed examples are applicable to both licensed and unlicensed operations.

For example, a UE is configured with multiple PUCCH-SR configurations. For at least one SR configuration, the UE is configured with a set of uplink beams or beam candidates. Different from the existing SR failure handling in NR, for this SR configuration, an SR failure is triggered when the first condition is met or when both of the 2 conditions are met:
1) the UE has attempted SR transmissions on all or a subset of the active uplink beam candidates in the set associated with the SR configuration; and/or
2) SR COUNTER of the SR configuration has reached sr-TransMax of the SR configuration. In other words, the UE has reached the maximum transmission attempts for an SR configuration.

As a note, a subset of beams may comprise some or all the beams in the set.

The UE is allowed to try or select beams that have different directions when sending the different SR transmissions.

As such, the SR transmission mechanism is enhanced for a UE so that the UE is allowed to perform autonomous beam switch from one direction to another direction in case the UE does not receive a grant as a response to its SR transmission in a direction.

For a SR configuration configured with a set of uplink beams or beam candidates, the set of uplink beam candidates can be configured as a set of spatial relations. As such, the UE can be configured with a set of beams/spatial relations for PUCCH by the gNB, which allows the UE to perform autonomous beam switch (i.e., changes from one beam in the set to a different beam in the set). The set is configured by the gNB via at least one of the below signaling options.

Option 1: using RRC signaling, the set of beams/spatial relations may be signaled using the existing RRC Information Element (IE) PUCCH-SpatialRelationInfo. Alternatively, a separate RRC IE can be defined to configure a different set of beams/spatial relations. Compared to the set configured via PUCCH-SpatialRelationInfo, the UE can select any beam in this set of beams/spatial relations to transmit PUCCH (e.g., PUCCH-SR) without relying on reception of a second signaling (such as a MAC CE) to activate the selected beam.

Option 2: using MAC CE, the set of beams/spatial relations may be signaled using a MAC CE. In the MAC CE, for each PUCCH resource, there is at least one beam/spatial relation configured. Alternatively, the gNB uses a MAC CE to signal the UE to add or remove beams/spatial relations for a specific PUCCH resource. The existing MAC CE, i.e. “PUCCH spatial relation Activation/Deactivation MAC CE” or “Enhanced PUCCH spatial relation Activation/Deactivation MAC CE” can be used for adding or removing beams/spatial relations for a specific PUCCH resource.

Option 3: using DCI, the set of beams/spatial relations may be signaled using a DCI. In the DCI, for each PUCCH resource, there is at least one beams/spatial relations configured. Alternatively, the gNB uses a DCI to signal the UE to add or remove beams/spatial relations for a specific PUCCH resource.

Alternatively, a hard rule may be captured in the standard specification that the gNB may use a single index or single indicator in the signaling (such as RRC, MAC CE or DCI) to represent multiple beams or spatial relations for a specific PUCCH resource. In a non-limiting example, an index with value “n” may represent the beam with index 2*n, and the beam with index 2*n-1. Optionally, the hard rule can be made flexible and configurable, so that the index with value “n” can point to different beams.

The gNB can activate one or multiple spatial relations out of the set using at least one of the following signaling means: RRC signaling, MAC control element (MAC CE) and DCI.

The update will typically come as a response to the UE having reported a stronger received power for another reference signal than the one the current spatial relation is associated with. Thus, as the UE moves around in the cell, the UE provides CSI reports to the gNB, based on which the gNB will update the currently active spatial relation.

For an SR configuration which is configured with a set of uplink beams or beam candidates, at least one of the below parameters are added into the SR configuration for configuring beam-based transmission patterns:
1) maximum number of transmissions using the same beam: if the SR transmission on the same beam has reached that maximum number, the UE needs to switch to another beam candidate;
2) maximum time period of transmissions using the same beam: if the SR transmission on the same beam has reached that maximum time period, the UE needs to switch to another beam candidate;
3) minimum number of transmissions using the same beam: before switching to another beam candidate, the UE needs to transmit SRs for at least this number of times.
4) minimum time period of transmissions using the same beam: before switching to another beam candidate, the UE needs to transmit SRs for at least this time period.
5) minimum number of different beams within the set of beam candidates that the UE may try before declaring a SR failure;
6) beam specific transmission power offsets: different UL beams may have different transmission powers defined by an offset to the preferred beam. For example, the preferred UL beam is associated with the strongest SSBs or CSI-RSs which has been reported by the UE to have the strongest received power.

When applying the configurations above, for each beam, in relation to UE autonomous beam switch triggering, a configured time period or a configured number of transmission attempts is configured which allows the UE to switch to a different beam if the UE does not receive a grant as a response to its SR transmission, from the gNB after the configured time period since the first transmission attempt has expired or the configured maximum number of transmission attempts on the current beam has been reached. An example can be that the UE tries SR transmissions for “N” times or “x” ms before switching to another beam.

In addition, for any of the above parameters/configurations, the parameters may be configured per beam candidate.

In another example, multiple SR configurations may be associated with different sets of candidate beams, or the same set of candidate beams.

In another example, for an SR configuration which is configured with a set of uplink beam candidates, a priority index is configured for each beam. Following a decreasing priority order, the UE switches SR transmissions from one beam to another beam. Alternatively, the UE can switch beams following another priority order, for example.

In another example, a UE capability bit for indicating whether the UE supports beam switch for SR is defined. For example, the gNB sends a message to the UE; the message can be an UECapabilityEnquiry. Then, the UE replies back with a message, which contains an UECapabilityInformation, for example.

In another example, the SR counter is only incremented when the UE does consecutive transmissions using the same UL beam, i.e. if the UE changes beams, the first transmission with the new beam does not increment the SR counter. As a variant, the SR counter is only updated when the UE transmits on a beam where it has previously transmitted a SR. As another variant, the SR counter is only incremented when the UE changes UL transmission beams. If the UE does not change beams between successive transmissions, the SR counter is not incremented.

In case of a SR failure for an SR configuration, e.g. after the UE has attempted all or a specified subset of the configured beams/spatial relations for a triggered PUCCH-SR and/or the UE has reached the maximum transmission attempts for the triggered SR , the UE fallbacks to a RACH configuration to initiate a RACH via at least one of the below options.

Option 1: the UE is configured with a plurality of RACH configurations corresponding to a plurality of SR configurations. The plurality of SR configurations is associated with different Logical Channels (LCHs)/services. As such, there is a corresponding RACH configuration mapped to a SR configuration. In this case, for an SR configuration associated with high priority LCHs/services, the UE can find a corresponding RACH configuration to initiate a RA procedure. Similarly, for an SR configuration associated with low priority LCHs/services, the UE can also find a corresponding RACH configuration to initiate a RA procedure. The RACH configuration may be contention free (CFRA) meaning that the UE is assigned with a specific set of preambles or RACH occasions (ROs).

Option 2: there is no specific RACH configuration mapped to the SR configuration. Instead, there are specific PRACH preambles/resources (such as RACH occasions) mapped to the SR configuration. The UE uses one PRACH preamble/resource to transmit a RACH for the SR configuration (or to transmit the SR configuration). Upon reception of the RACH transmission, the gNB is aware that the UE has triggered an SR for this SR configuration.

Furthermore, a 4-step RACH based Random Access (RA) procedure can be initiated for the triggered SR in the SR configuration. The triggered SR means the SR (or SR configuration) that is selected among a plurality of SR configurations.

In an example, Msg1 (or a first message) is used to identify the triggered SR and its associated the SR configuration. Dedicated preambles or dedicated RACH occasions may be allocated to the UE for indicating the triggered SR and its associated SR configuration. The allocation may be pre-defined, determined based on a pre-defined rule, or configured by another node.

In an example, Msg3 (or a third message) is extended to identify the triggered SR and its associated SR configuration. In Msg3, the UE MAC entity adds an indicator indicating the triggered SR and its associated SR configuration. The indicator may be a field in the MAC subheader or carried in a MAC CE.

A 2-step RACH based Random Access procedure can be triggered to indicate the triggered SR and its associated SR configuration. Dedicated preambles or dedicated RACH occasions or dedicated PUSCH occasions/resources may be allocated to the UE for indicating the triggered SR and its associated SR configuration. Alternatively, indicators indicating the triggered SR and its associated SR configuration can be included in a MsgA payload. The indicator may be a field in the MAC subheader or carried in a MAC CE.

Alternatively, an RRC message (partly or fully) may be included in a RACH message, which includes indicators of the triggered SR and its associated SR configuration.

In another example of SR failure, the UE can first fallback to a 2-step RACH configuration to initiate a RA procedure. After a configured number of RACH transmission attempts has been reached, or a configured time period for RACH transmission attempts has expired, if the UE has not received a grant as a response to the SR transmissions, the UE can further fallback to a 4-step RACH configuration to initiate a RA procedure.

As mentioned above, a UE can be configured with a set of PUCCH-SR resources/configurations and a set of RACH resources/configurations. For a triggered SR, the UE may choose to transmit the SR via a PUCCH-SR resource or a RACH resource based on one of the below conditions.
Signaling from the gNB; the gNB may send signaling to a UE on the transmission choice for a specific SR event to either use PUCCH-SR resource, or 2-step RACH resource, or 4-step RACH resource. As a note, for every beam/spatial relation, the signaled transmission choice may be different.
Measured radio quality in terms of the measurement quantities such as RSRP, RSRQ, SINR, RSSI, channel occupancy, and LBT/CCA failure statistics (such as failure counter, or failure ratio) etc. Based on the measurement results, the UE selects a corresponding transmission choice.

For example, the UE can choose a PUCCH-SR resource only in case of the measured RSRP of a beam/spatial relation being above a configured first threshold.

For example, the UE can choose a 2-step RACH resource only in case of the measured RSRP of a beam/spatial relation being below a configured first threshold and above a second configured threshold. The UE can choose a 4-step RACH resource only in case of the measured RSRP of a beam/spatial relation being below a second configured threshold. Different thresholds and conditions can be configured for choosing the different resources/transmission choices.
If the UE measurements indicate that the configured spatial relation is no longer optimal, e.g. the highest measured signal strength on the SSBs or CSI-RS does not correspond to the configured spatial relation, the UE can choose to use either 2-step or 4-step RACH resource to initiate a RA procedure where it also has the option to select and indicate the new preferred beam.

For any of the above options, after transmission of the SR using a first resource type for a configured time period or a configured maximum number of transmission attempts, if the UE cannot get a grant as a response to its transmitted SR, the UE can switch to a second resource type. After transmission of the SR using the second resource type for a configured time period or a configured maximum number of transmission attempts, if the UE cannot get a grant as a response to its transmitted SR, the UE can switch to a third resource type to continue transmitting the SR.

For any of the above examples, whenever the UE performs a switch between a first SR resource type to a second SR resource type, the UE may provide a report/request message to the gNB, informing the gNB of at least one of the below information fields:
Number of SR transmissions which have been attempted using the first SR resource type;
Time period during which the SR transmissions have been attempted using the first SR resource type;
LCHs/LCGs, and/or SR configurations associated with which SRs have been triggered/selected/used;
Uplink beams/spatial relations with which SR transmissions have been attempted using the first SR resource type.

The report/request message may be carried by the UE via at least one of the below signaling options: 1) an RRC signaling, 2) a MAC CE and 3) a UCI, carried on PUCCH or PUSCH.

Furthermore, the UE can send a message to the gNB, the message comprising a UE capability bit (or a UE capability information) indicating whether the UE supports switching between SR resource types.

Now turning to FIG. 2, a flow chart of a method 200 in a wireless device configured with multiple scheduling request (SR) configurations and a set of uplink beam candidates for at least one of the SR configurations will be described. Method 200 comprises:
Step 210: transmitting a SR to a network node using a first uplink beam of the set;
Step 220: determining a second uplink beam from the set to retransmit the SR, in absence of receiving a grant of resources for data transmissions;
Step 230: triggering a SR failure after transmitting the SR using a subset of the uplink beams of the set.

In some examples, the wireless device may further trigger the SR failure after reaching a maximum number of transmissions associated with the SR configurations.

Some examples (and/or more details) of this method has been described above.

FIG. 3 illustrates a flow chart of a method 300 in a network node, such as gNB, for controlling triggering of Scheduling Request (SR) failure for a wireless device configured with a plurality of SR configurations and a set of uplink beam candidates/beams. Method 300 comprises:
Step 310: configuring a SR failure to be triggered after the wireless device has transmitted the SR using a subset of the uplink beams of the set;
Step 320: sending the configuration to the wireless device.

In some examples, the network node may further configure a SR failure to be triggered after the wireless device has transmitted the SR for a maximum number of transmissions associated with a SR configuration.

Some examples (and/or more details) of this method has been described above.

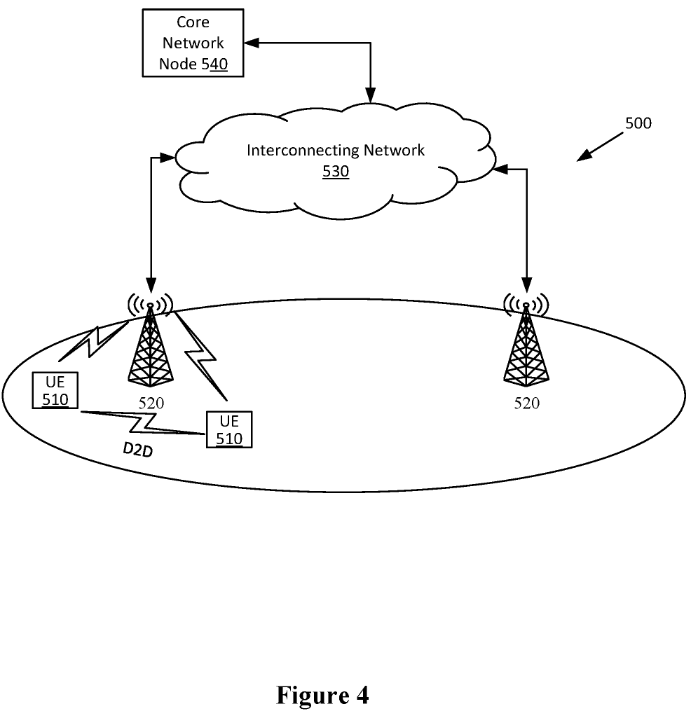

FIG. 4 illustrates an example of a wireless network 500 that may be used for wireless communications. Wireless network 500 includes UEs 510 and a plurality of radio network nodes 520 (e.g., Node Bs (NBs) Radio Network Controllers (RNCs), evolved NBs (eNBs), next generation NB (gNBs), etc.) directly or indirectly connected to a core network 530 which may comprise various core network nodes. The network 500 may use any suitable radio access network (RAN) deployment scenarios, including Universal Mobile Telecommunication System (UMTS) Terrestrial Radio Access Network (UTRAN), and Evolved UMTS Terrestrial Radio Access Network (EUTRAN). UEs 510 may be capable of communicating directly with radio network nodes 520 over a wireless interface. In certain embodiments, UEs may also be capable of communicating with each other via device-to-device (D2D) communication. In certain embodiments, network nodes 520 may also be capable of communicating with each other, e.g. via an interface (e.g. X2 in LTE or other suitable interface).

As an example, UE 510 may communicate with radio network node 520 over a wireless interface. That is, UE 510 may transmit wireless signals to and/or receive wireless signals from radio network node 520. The wireless signals may contain voice traffic, data traffic, control signals, and/or any other suitable information. In some embodiments, an area of wireless signal coverage associated with a radio network node 520 may be referred to as a cell.

It should be noted that a UE may be a wireless device, a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), Universal Serial Bus (USB) dongles, Customer Premises Equipment (CPE) etc.

In some embodiments, the “network node” can be any kind of network node which may comprise of a radio network node such as a radio access node (which can include a base station, radio base station, base transceiver station, base station controller, network controller, gNB, NR BS, evolved Node B (eNB), Node B, Multi-cell/multicast Coordination Entity (MCE), relay node, access point, radio access point, Remote Radio Unit (RRU), Remote Radio Head (RRH), a multistandard BS (also known as MSR BS), etc.), a core network node (e.g., MME, SON node, a coordinating node, positioning node, MDT node, etc.), or even an external node (e.g., 3rd party node, a node external to the current network), etc. The network node may also comprise a test equipment.

In certain embodiments, network nodes 520 may interface with a radio network controller (not shown). The radio network controller may control network nodes 520 and may provide certain radio resource management functions, mobility management functions, and/or other suitable functions. In certain embodiments, the functions of the radio network controller may be included in the network node 520. The radio network controller may interface with the core network node 540. In certain embodiments, the radio network controller may interface with the core network node 540 via the interconnecting network 530.

The interconnecting network 530 may refer to any interconnecting system capable of transmitting audio, video, signals, data, messages, or any combination of the preceding. The interconnecting network 530 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the core network node 540 may manage the establishment of communication sessions and various other functionalities for wireless devices 310. Examples of core network node 540 may include MSC, MME, SGW, PGW, O&M, OSS, SON, positioning node (e.g. E-SMLC), MDT node, etc. Wireless devices 110 may exchange certain signals with the core network node 540 using the non-access stratum layer. In non-access stratum signaling, signals between wireless devices 510 and the core network node 540 may be transparently passed through the radio access network. In certain embodiments, network nodes 520 may interface with one or more other network nodes over an internode interface. For example, network nodes 520 may interface each other over an X2 interface.

Although FIG. 4 illustrates a particular arrangement of network 500, the present disclosure contemplates that the various embodiments described herein may be applied to a variety of networks having any suitable configuration. For example, network 500 may include any suitable number of wireless devices 510 and network nodes 520, as well as any additional elements suitable to support communication between wireless devices or between a wireless device and another communication device (such as a landline telephone). The embodiments may be implemented in any appropriate type of telecommunication system supporting any suitable communication standards and using any suitable components and are applicable to any radio access technology (RAT) or multi-RAT systems in which the wireless device receives and/or transmits signals (e.g., data). While certain embodiments are described for NR and/or LTE, the embodiments may be applicable to any RAT, such as UTRA, E-UTRA, narrow band internet of things (NB-IoT), WiFi, Bluetooth, next generation RAT (NR, NX), 4G, 5G, LTE FDD/TDD, etc. Furthermore, the communication system 500 may itself be connected to a host computer. The network 500 (with the wireless devices 510 and network nodes 520) may be able to operate in LAA or unlicensed spectrum.

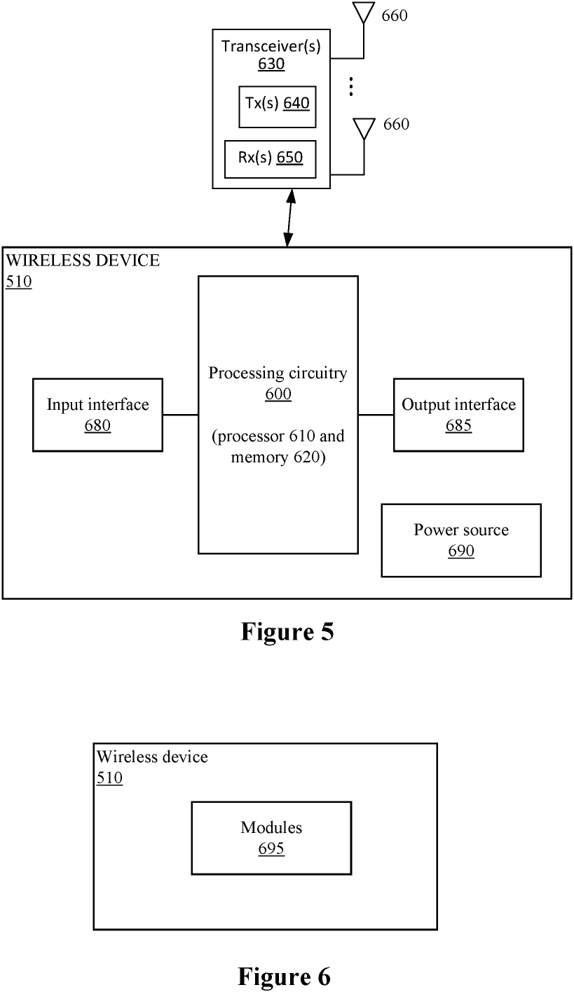

FIG. 5 is a schematic block diagram of the wireless device 510 according to some embodiments of the present disclosure. As illustrated, the wireless device 510 includes circuitry 600 comprising one or more processors 610 (e.g., Central Processing Units (CPUs), Application Specific Integrated Circuits (ASICs), Field Programmable Gate Arrays (FPGAs), and/or the like) and memory 620. The wireless device 510 also includes one or more transceivers 630 each including one or more transmitters 640 and one or more receivers 650 coupled to one or more antennas 660. Furthermore, the processing circuitry 600 may be connected to an input interface 680 and an output interface 685. The input interface 680 and the output interface 685 may be referred to as communication interfaces. The wireless device 510 may further comprise power source 690.

In some embodiments, the functionality of the wireless device 510 described above may be fully or partially implemented in software that is, e.g., stored in the memory 620 and executed by the processor(s) 610. For example, the processor 610 is configured to perform all the functionalities performed by the wireless device 510. For example, the processor 610 can be configured to perform any steps of the method 200 FIG. 2.

In some embodiments, a computer program including instructions which, when executed by the at least one processor 610, causes the at least one processor 610 to carry out the functionality of the wireless device 510 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the wireless device 510 according to some other embodiments of the present disclosure. The wireless device 510 includes one or more modules 695, each of which is implemented in software. The module(s) 695 provide the functionality of the wireless device 510 described herein. The module(s) 695 may comprise a transmitting module operable to perform step 210 of FIG. 2, a determining module operable to perform step 220 of FIG. 2 and a triggering module operable to perform step 230 of FIG. 2.

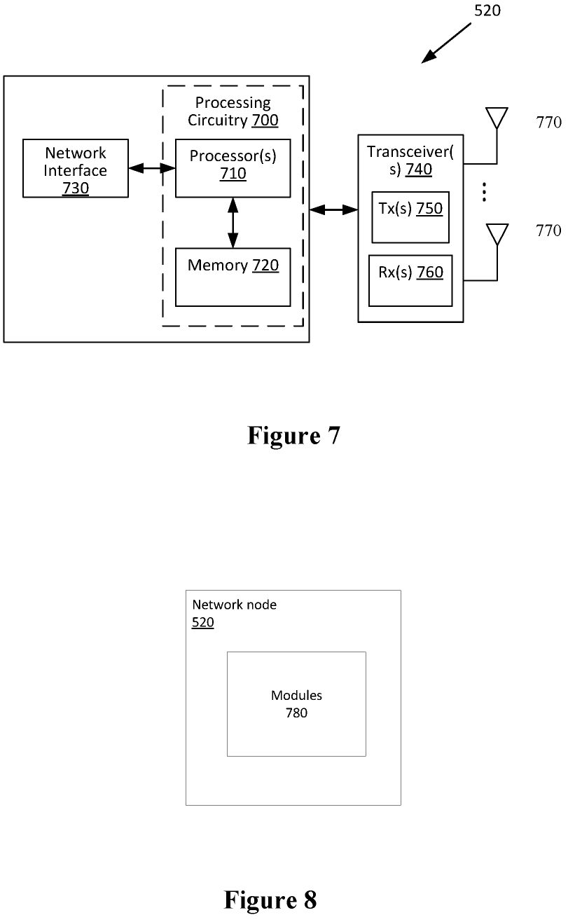

FIG. 7 is a schematic block diagram of a network node 520 according to some embodiments of the present disclosure. As illustrated, the network node 520 includes a processing circuitry 700 comprising one or more processors 710 (e.g., CPUs, ASICs, FPGAs, and/or the like) and memory 720. The network node also comprises a network interface 730. The network node 320 also includes one or more transceivers 740 that each include one or more transmitters 750 and one or more receivers 760 coupled to one or more antennas 770. In some embodiments, the functionality of the network node 520 described above may be fully or partially implemented in software that is, e.g., stored in the memory 720 and executed by the processor(s) 710. For example, the processor 710 can be configured to perform any steps of the method 300 of FIG. 3.

FIG. 8 is a schematic block diagram of the network node 520 according to some other embodiments of the present disclosure. The network node 520 includes one or more modules 780, each of which is implemented in software. The module(s) 780 provide the functionality of the network node 520 described herein. The module(s) 780 may comprise a sending module operable to perform step 320 of FIG. 3 and a configuring module operable to perform 310 of FIG. 3.

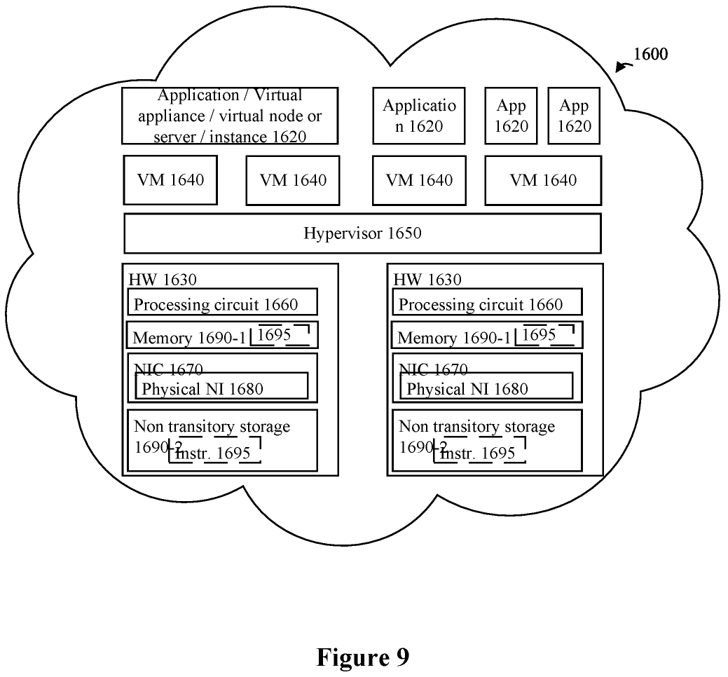

FIG. 9 is a schematic block diagram that illustrates a virtualized embodiment of the wireless device 510 or network node 520, according to some embodiments of the present disclosure. As used herein, a “virtualized” node 1600 is a network node 520 or wireless device 510 in which at least a portion of the functionality of the network node 520 or wireless device 510 is implemented as a virtual component (e.g., via a virtual machine(s) executing on a physical processing node(s) in a network(s)). For example, in FIG. 10, there is provided an instance or a virtual appliance 1620 implementing the methods or parts of the methods of some embodiments. The one or more instance(s) runs in a cloud computing environment 1600. The cloud computing environment provides processing circuits 1630 and memory 1690-1 for the one or more instance(s) or virtual applications 1620. The memory 1690-1 contains instructions 1695 executable by the processing circuit 1660 whereby the instance 1620 is operative to execute the methods or part of the methods described herein in relation to some embodiments.

In some embodiments, a carrier comprising the aforementioned computer program product is provided. The carrier is one of an electronic signal, an optical signal, a radio signal, or a computer readable storage medium (e.g., a non-transitory computer readable medium such as memory).

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description, which is defined solely by the appended claims.

1. A method in a wireless device configured with multiple scheduling request (SR) configurations and a set of uplink beam candidates for at least one of the SR configurations, the method comprising:
transmitting a SR to a network node using a first uplink beam of the set;
determining a second uplink beam from the set to retransmit the SR, in absence of receiving a grant of resources for data transmissions; and
triggering a SR failure after transmitting the SR using a subset of the uplink beams of the set.

2. The method of claim 1, further comprising triggering the SR failure after reaching a maximum number of transmissions associated with the SR configurations.

3. The method of claim 1, further comprising, prior to determining the second uplink beam, retransmitting the SR using the first uplink beam for at least one of a maximum number of transmissions and a maximum period of time.

4. (canceled)

5. The method of claim 1, further comprising retransmitting the SR using the first uplink beam for a minimum number of transmissions before using another beam to retransmit the SR.

6. The method of claim 1 , further comprising retransmitting the SR using the first uplink beam for a minimum period of time before using another beam to retransmit the SR.

7. The method of claim 1, further comprising retransmitting the SR using a minimum number of different beams of the set before triggering the SR failure.

8. (canceled)

9. The method of claim 1, wherein the first beam has a different direction than the second beam.

10. (canceled)

11. (canceled)

12. (canceled)

13. The method of claim 1, wherein each beam of the set of uplink beam candidates is associated with a priority index.

14. (canceled)

15. (canceled)

16. The method of claim 1, wherein a SR counter is incremented when the wireless device does consecutive transmissions using a same uplink beam.

17. (canceled)

18. The method of incremented when the wireless device changes uplink beams for transmitting the SR.

19. The method of claim 1, further comprising receiving a signaling from a network node, the signaling comprising an indication of a type of resource to be used for transmitting the SR.

20. (canceled)

21. The method of claim 1, further comprising selecting a PUCCH-SR resource to be used for transmitting the SR, in response to determining that a measured RSRP of a beam is above a configured first threshold.

22. The method of claim 1, further comprising selecting a 2-step RACH resource to be used for transmitting the SR, in response to determining that a measured RSRP of a beam is below a configured first threshold and above a second configured threshold.

23. The method of claim 1, further comprising selecting a 4-step RACH resource to be used for transmitting the SR, in response to determining that a measured RSRP of a beam is below a second configured threshold.

24. The method of claim 1, further comprising selecting one of a 2-step and a 4-step RACH resource to initiate a RACH procedure, in response to determining that measurements indicate that a configured spatial relation is no longer optimal.

25. The method of claim 1, further comprising, in response to not receiving a transmission grant after transmitting the SR using an indicated type of resource for a configured time period or configured maximum number of transmission attempts, selecting a second type of resource to transmit the SR.

26. The method of claim 1, further comprising sending a report to the network node, the report comprising one or more of: a number of SR transmissions which have been attempted using an indicated SR resource type, a time period during which the SR transmissions have been attempted using the indicated SR resource type, Logical Channels (LCHs)/Logical Channel Groups (LCGs), SR configurations associated with current SRs and Uplink beams which SR transmissions have been attempted using the indicated SR resource type.

27. (canceled)

28. The method of claim 1, wherein triggering a SR failure comprises initiating one of a random access (RA) procedure, a 2-step RA procedure and a 4 step RA procedure.

29. (canceled)

30. (canceled)

31. (canceled)

32. A wireless device comprising a communication interface and processing circuitry connected thereto and configured to:
transmit a SR to a network node using a first uplink beam of the set; determine a second uplink beam from the set to retransmit the SR, in abscence of resceiving a grant of resources for data transmissions; and
trigger a SR failure after transmitting the SR using a subset of the uplink beams of the set.

33. A method in a network node for controlling triggering of Scheduling Request (SR) failure for a wireless device configured with a plurality of SR configurations and a set of uplink beams, the method comprising:
configuring a SR failure to be triggered after the wireless device has transmitted the SR using a subset of the uplink beams of the set; and
sending the configuration to the wireless device.

34-49. (canceled)
